(19) United States
(12) Patent Application Publication
(10) Pub. No.: US 2018/0032350 A1
(43) Pub. Date: Feb. 1, 2018

(54) METHOD FOR RECOGNIZING EXTERNAL DEVICE AND ELECTRONIC DEVICE SUPPORTING THE SAME

(71) Applicant: Samsung Electronics Co., Ltd., Suwon-si (KR)

(72) Inventors: Woo Kwang LEE, Suwon-si (KR); One Gun LEE, Seoul (KR); Woo Jin KIM, Yongin-si (KR); Dong Rak SHIN, Gwangju-si (KR)

(21) Appl. No.: 15/663,151

(22) Filed: Jul. 28, 2017

(30) Foreign Application Priority Data
Aug. 1, 2016 (KR) 10-2016-0098237

(51) Int. Cl. G06F 9/44

(52) U.S. Cl. CPC G06F 9/4411; G06F 13/12

(57) ABSTRACT

An electronic device is provided that includes a connector configured to connect to an external electronic device that includes a recognition pin for sensing the connection, a connection configuration module configured to control an operation of the connector by using the recognition pin, and a processor configured to control the connector and the connection configuration module, wherein the processor is configured to, if the external electronic device is connected to the connector, verify through the recognition pin whether communication of a power delivery (PD) message is possible, and perform at least one of switching of a role associated with power supply of the electronic device or switching of a role associated with data transfer thereof by using at least one of a way to convey the PD message or a way to change a resistor connected to the recognition pin, depending on whether communication of the PD message is possible.

### CROSS-REFERENCE TO RELATED APPLICATION(S)

This application claims the benefit under 35 U.S.C. § 119(a) of a Korean patent application filed on Aug. 1, 2016 in the Korean Intellectual Property Office and assigned Serial number 10-2016-0098237, the entire disclosure of which is hereby incorporated by reference.

### TECHNICAL FIELD

The present disclosure relates to a method for connecting an external electronic device through a connector and recognizing the external electronic device and an electronic device supporting the same.

### BACKGROUND

An electronic device such as a smartphone, a tablet, or the like may be connected to various external electronic devices. The electronic device may be connected to a personal computer (PC), a smartphone, an accessory device, or a universal serial bus (USB) storage device for charging or to send and receive various data signals.

A recent electronic device may support a dual role port (DRP) function that is able to operate as a host device or a client device depending on a kind of the external electronic device connected thereto.

In the case where a related-art electronic device is connected to an external electronic device that performs the DRP function by using a cable of a USB type C shape, the related-art electronic device may determine a power-related role (source device/sink device) and a data-related role (host device/client device), depending on a resistance value recognized at a configuration channel (CC). The related-art electronic device may interchange the power-related role and the data-related role through changing a resistance value. In this case, there is a limitation on a way to connect with a related-art external device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below.

In accordance with an aspect of the present disclosure, an electronic device is provided. The electronic device includes a connector configured to connect to an external electronic device, the connector including a recognition pin for sensing a connection with the external electronic device, a connection configuration module configured to control an operation of the connector by using the recognition pin, and a processor configured to control the connector and the connection configuration module, wherein the processor is configured to, if the external electronic device is connected to the connector, verify through the recognition pin, verify through the recognition pin whether communication of a power delivery (PD) message is possible, and perform at least one of switching of a role associated with power supply of the electronic device or switching of a role associated with data transfer thereof by using at least one of a way to convey the PD message or a way to change a resistor connected to the recognition pin, depending on whether communication of the PD message is possible.

In accordance with an aspect of the present disclosure, a method for recognizing an external electronic device, executed by an electronic device, is provided. The method includes recognizing a connection of a connector, mounted on the electronic device, with the external electronic device, verifying through a recognition pin included in the connector whether communication of a PD message is possible, and performing at least one of switching of a role associated with power supply of the electronic device or switching of a role associated with data transfer thereof by using at least one of the PD message or a way to change a resistor connected to the recognition pin, by using at least one of the PD message or a resistor connected to the recognition pin, depending on whether communication the PD message is possible.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device according to various embodiments of the present disclosure;

FIG. 2 illustrates a pinout of a connector according to various embodiments of the present disclosure;

FIG. 3A is a flowchart illustrating a process for verifying a PD communication ready state at a source device, according to various embodiments of the present disclosure;

FIG. 3B is a flowchart illustrating a process for verifying a PD communication ready state at a sink device, according to various embodiments of the present disclosure;

FIG. 4 is a flowchart for describing switching of a power-related role or a data-related role using a PD message according to various embodiments of the present disclosure;

FIG. 5 is a flowchart for describing switching of the power-related role or the data transfer-related role using a resistor change, according to various embodiments of the present disclosure;

FIG. 6A is a screen exemplification view for describing switching of the power-related role or the data transfer-related role according to selection of a user, according to various embodiments of the present disclosure;

FIG. 6B is a screen exemplification view illustrating a change of a user interface according to role switching failure, according to various embodiments of the present disclosure;

FIG. 7 is an exemplification view illustrating switching of the power-related role according to a connection with a power device, according to various embodiments of the present disclosure;

FIGS. 8 and 9 are flowcharts for describing a process for initial connection with an external electronic device, according to various embodiments of the present disclosure;

FIG. 10 illustrates the electronic device in a network environment of the present disclosure; and

FIG. 11 illustrates a block diagram of the electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. Central processing unit (CPU), for example, a “processor configured to (or set to) perform A, B, and C” may mean a dedicated processor (for example, an embedded processor) for performing a corresponding operation or a generic-purpose processor (for example, a CPU or an application processor (AP)) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disc (DVD) player, an audio, a refrigerator, an air conditioner, a cleaner, an oven, a microwave oven, a washing machine, an air cleaner, a set-top box, a home automation control panel, a security control panel, a television (TV) box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

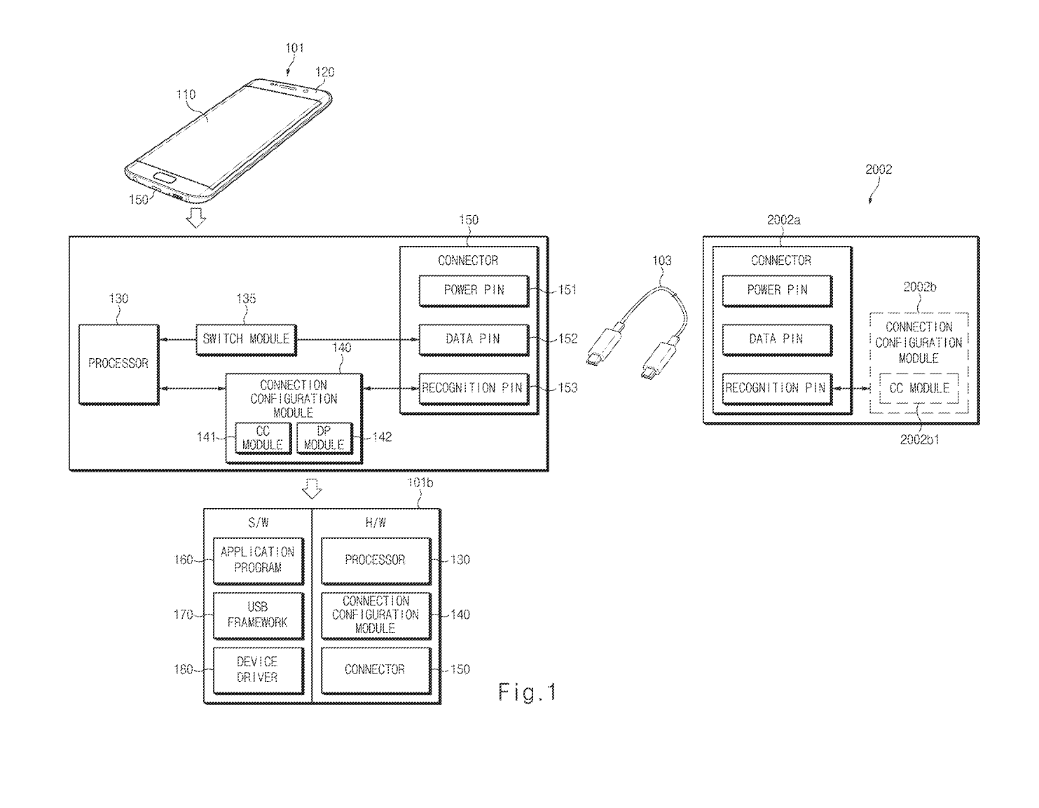

FIG. 1 illustrates an electronic device according to various embodiments of the present disclosure.

Referring to FIG. 1, an electronic device 101 may include a display 110 and a body (or housing) 120.

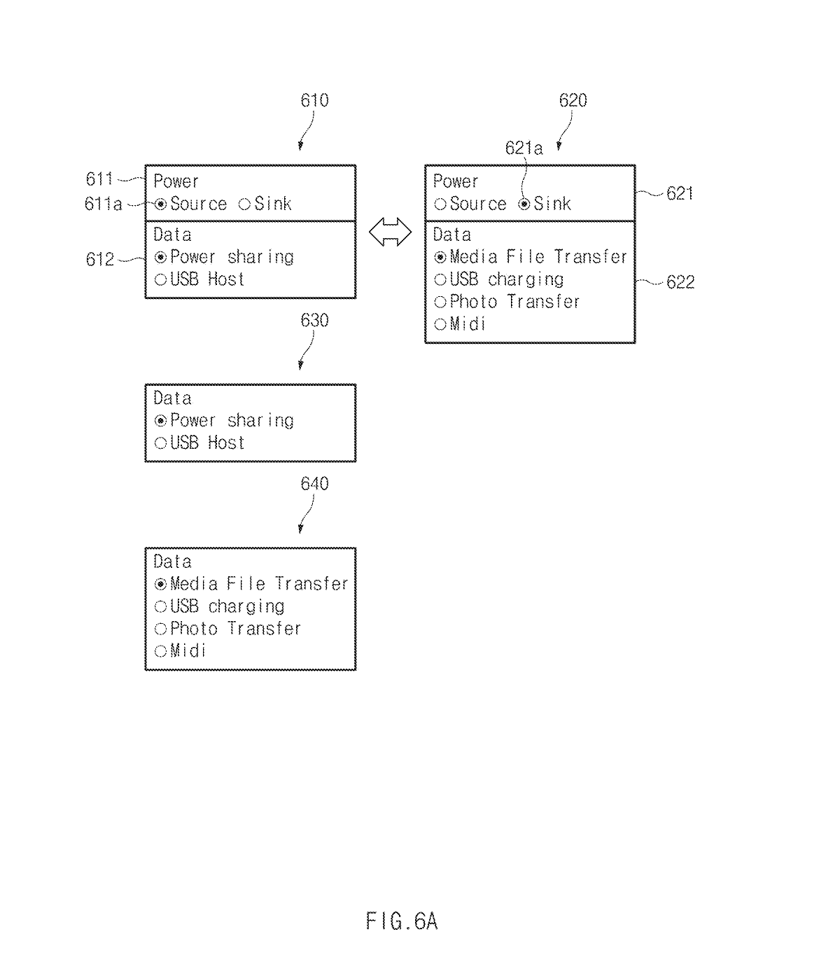

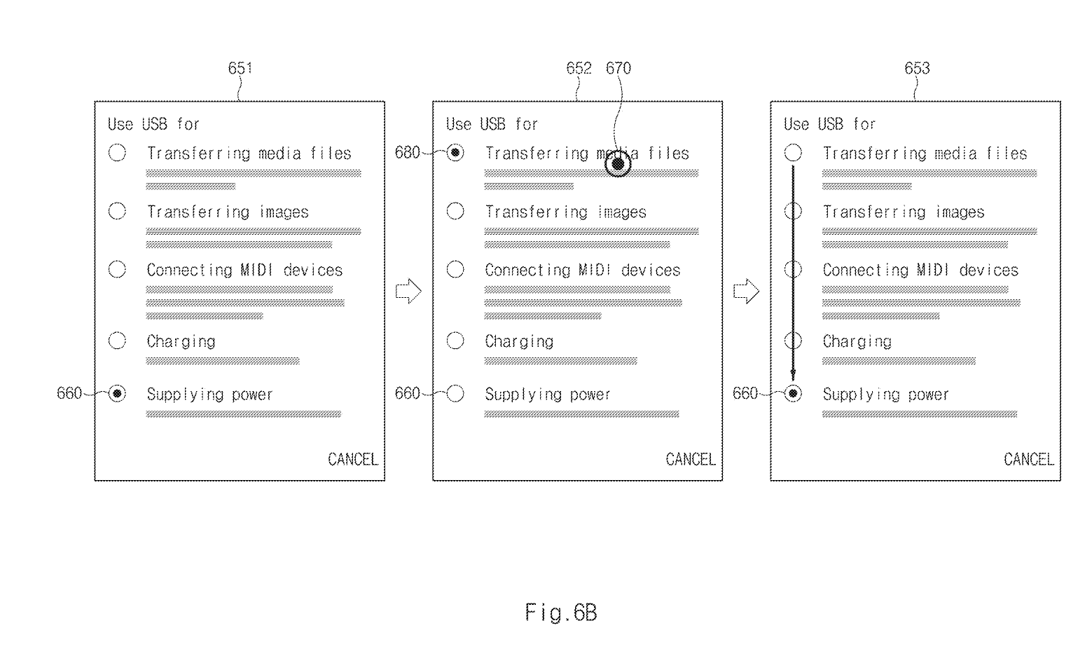

The display 110 may output content such as an image, a text, or the like. According to various embodiments, the display 110 may output a user interface for determining a power delivery (PD) direction or a data transfer direction using a connector 150. A user may select a desired power option or data option in the output user interface. The user interface output in the display 110 will be additionally described with reference to FIGS. 6A and 6B.

The display 110 and peripheral parts (e.g., a camera, a physical button, and a sensor window) may be mounted on the body 120. In various embodiments, the connector 150 may be mounted on the body 120. The electronic device 101 may be connected with an external electronic device 2002 (e.g., a PC, a smartphone, an accessory device, or a storage device) to send and receive a power signal or a data signal.

The connector 150 may be connected with a connector 2002a of the external electronic device 2002 directly or through a separate cable 103. The connector 150 may transfer a power signal or a data signal between the electronic device 101 and the external electronic device 2002. The connector 150 may include at least one pin for sending and receiving data if the connector 150 is connected with the connector 2002a of the external electronic device 2002. According to an embodiment, the at least one pin included in the connector 150 may include a contact for electrical connection.

According to various embodiments, the connector 150 may be a universal serial bus (USB) type-C connector which is specified in the USB standard. In this case, an external connector may be inserted into the connector 150 without a limitation on top and bottom input directions.

According to various embodiments, the connector 150 may include a power pin 151, a data pin 152, and a recognition pin 153. The power pin 151 may refer to a pin through which a power signal is sent and received, and the data pin 152 may refer to a pin for sending and receiving data between the electronic device 101 and the external electronic device 2002.

The recognition pin 153 may refer to a pin for sending and receiving a signal needed to perform functions such as connection detection, identification of cable type, interface configuration, vendor defined messages, or the like. For example, the recognition pin 153 may refer to a configuration channel (CC) pin complying with the USB Type-C™ standard of USB implementers forum (USB-IF) (USB.org).

The electronic device 101 may include a processor 130, a switch module 135, and a connection configuration module 140 as elements for processing signals exchanged through the connector 150.

The processor (or AP) 130 may perform data processing or an operation associated with control and/or communication of at least one other element(s) of the electronic device 101. For example, the processor 130 may process a signal received through the switch module 135. The processor 130 may control the connection configuration module 140 by using a specified communication manner (e.g., I2C).

The switch module 135 may change a path for sending and receiving data depending on a kind of an external electronic device connected to the connector 150. For example, the switch module 135 may send received data to various circuits (not illustrated) (e.g., a USB communication circuit, a universal asynchronous receiver/transmitter (UART) communication circuit, an audio communication circuit, or an image communication circuit (e.g., a high definition multimedia interface (HDMI), a mobile high-definition link (MHL), or the like)) in the processor 130 depending on a kind of the external electronic device 2002 connected to the connector 150 and a kind of data to be sent and received.

The connection configuration module 140 (e.g., a CC integrated circuit (IC)) may control an operation of the connector 150. According to an embodiment, the connection configuration module 140 may be implemented with a chip independent of the processor 130 or may be included in the processor 130.

According to various embodiments, the connection configuration module 140 may send a discovery identity message to the external electronic device 2002 through the recognition pin (e.g., a CC pin) 153 of the connector 150. The connection configuration module 140 may perform functions such as connection detection, identification of cable type, interface configuration, vendor defined messages, or the like.

According to various embodiments, the connection configuration module 140 may perform CC communication with the external electronic device 2002 depending on a method that is specified in the USB Type-C standard. For example, the connection configuration module 140 may send and/or receive a PD message to and/or from a connection configuration module 2002b of the external electronic device 2002. The PD message may be a communication protocol of a binary marked code (BMC) manner. According to various embodiments, the PD message may exchange the following information between the electronic device 101 and the external electronic device 2002: information about how much power is exchanged, information about determination of a power provider side and a power consumer side, and information about determination of a display port or a pin to be used for HDMI communication.

According to various embodiments, if the external electronic device 2002 is connected to the connector 150, the connection configuration module 140 may determine a power-related role or a data-related role of the electronic device 101 and the external electronic device 2002, based on information recognized through the recognition pin 153. For example, the connection configuration module 140 may determine whether the electronic device 101 operates as a host device (or downstream facing port (DFP)) or a client device (or upstream facing port (UFP)) in terms of data transfer. Also, the connection configuration module 140 may determine whether the electronic device 101 operates as a device (hereinafter referred to as a “source device”) supplying power or a device (hereinafter referred to as a “sink device”) supplied with power in terms of power supply.

According to various embodiments, the connection configuration module 140 may send and receive messages for switching of a power-related role or switching of a data-related role, by using communication (hereinafter referred to as “PD communication”) using the PD message. For example, in the case where the external electronic device 2002 is connected through the connector 150, the processor 130 (e.g., a device driver 180) may verify whether data communication through the PD message is possible, through the connection configuration module 140. The connection configuration module 140 may send and receive a message associated with switching a role to and from the external electronic device 2002 by using the PD message.

According to various embodiments, in the case where the electronic device 101 performs switching of a power-related role or switching of a data-related role by using the PD message, the electronic device 101 may selectively change the switching of the power-related role or the switching of the data-related role.

For example, the data-related role may be switched by using the PD message (e.g., a DR_SWAP message) in a state where the electronic device 101 operates as a source device and a host device and the external electronic device 2002 operates a sink device and a client device. In this case, the electronic device 101 may operate as a source device and a client device, and the external electronic device 2002 may operate a sink device and a host device. In the case where the data-related role is switched by using the PD message and the power-related role is maintained, in the connection configuration module 140, a resistance state connected to the recognition pin 153 may be maintained.

For another example, the power-related role may be switched by using the PD message (e.g., a PR_SWAP message) in a state where the electronic device 101 operates as a source device and a host device and the external electronic device 2002 operates a sink device and a client device. In this case, the electronic device 101 may operate as a sink device and a host device, and the external electronic device 2002 may operate a source device and a client device. In the case where the power-related role is switched by using the PD message and the data-related role is maintained, in the connection configuration module 140, a resistance state connected to the recognition pin 153 may be changed.

Information associated with switching of the power-related role or switching of the data-related role of the connection configuration module 140 will be additionally described with reference to separate drawings.

According to various embodiments, the connection configuration module 140 may include a CC module 141 and a PD module 142.

The CC module 141 may refer to a module that performs at least some functions of the CC standard of the USB Type-C™. The CC module 141 may communicate with a CC module 2002b1 in the connection configuration module 2002b of the external electronic device 2002 (or a cable 103).

The PD module 142 may refer to a module that performs at least some functions of the PD standard of the USB. The PD module 142 may process at least some PD messages. For example, in the case where the PD module 142 receives a signal to request a change of a power value from the external electronic device 2002, the PD module 142 may transfer the signal to a power management IC (PMIC) (not illustrated) in the electronic device 101. For another example, the PD module 142 may send and receive a PD message for switching of the power-related role or switching of the data-related role to and from the external electronic device 2002.

In various embodiments, the CC module 141 and the PD module 142 may be implemented with one chip or may be implemented with different chips, respectively.

In a program configuration diagram 101b of the electronic device 101, the electronic device 101 may include the processor 130, the connection configuration module 140, and the connector 150 as hardware elements and may include an application program 160, a USB framework 170, and the device driver 180 associated with the connection configuration module 140 as software elements.

The application program 160 may output a screen associated with power role settings and data transfer settings to the user and may collect information according to selection of the user. In the case where the external electronic device 2002 includes the connection configuration module 2002b, the USB framework 170 may play a role of managing device information. The device driver 180 may control the connection configuration module 140.

According to various embodiments, the device driver 180 may control operations (e.g., transfer and wait of a CC command and a PD command) of the connection configuration module 140. Below, various operations of the connection configuration module 140 may be performed through a software command of the device driver 180.

The external electronic device 2002 may be various types of devices such as a desktop PC, a USB storage device, a smartphone, an accessory device, and the like. In the case where the external electronic device 2002 includes the connection configuration module 2002b, the external electronic device 2002 may change the data-related role or the power-related role by using the PD message.

According to an embodiment, the connection configuration module 2002b of the external electronic device 2002 may include the CC module 2002b1 therein. The CC module 2002b1 may communicate with the CC module 141 in the connection configuration module 140 of the electronic device 101. The connection configuration module 2002b may not include a separate PD module.

According to another embodiment, the connection configuration module 2002b of the external electronic device 2002 may include the CC module 2002b1 and a PD module (not illustrated) therein. The PD module 142 that refers to a module to perform at least some functions of the PD standard of the USB may process at least some PD messages. For example, the PD module may send and receive the PD message for switching of the power-related role or switching of the data-related role.

According to another embodiment, the connection configuration module 2002b of the external electronic device 2002 may not include a CC module and a PD module therein. For example, the external electronic device 2002 may be a legacy cable in which one of a pull-down resistor or a pull-up resistor is connected to a recognition pin.

Based on resistance applied to the recognition pin 153, the electronic device 101 may determine whether to operate as a host device or a client device in terms of data transfer and may determine whether to operate as a source device supplying power or a sink device supplied with power in terms of PD.

For example, in the case where the external electronic device 2002 is a source/host device such as a desktop PC, in terms of data transfer, the electronic device 101 may operate as a client device (or an UFP) based on information recognized through the recognition pin 153, and the desktop PC may operate as a host device (or a DFP). Also, in terms of power supply, the electronic device 101 may operate as a sink device, and the desktop PC may operate as a source device.

For another example, in the case where the external electronic device 2002 is a sink/client device such as a USB storage device, in terms of data transfer, the electronic device 101 may operate as a host device based on information recognized through the recognition pin 153, and the USB storage device may operate as a client device. Also, in terms of power supply, the electronic device 101 may operate as a source device supplying power, and the USB storage device may operate as a sink device supplied with power.

For another example, in the case where the external electronic device 2002 is a DRP device such as a smartphone, in terms of data transfer, the electronic device 101 may operate as a host device, and the external electronic device 2002 may operate as a client device. In the case where the electronic device 101 operates as a client device, the external electronic device 2002 may operate as a host device. Also, in terms of power supply, in the case where the electronic device 101 operates as a source device supplying power, the external electronic device 2002 may operate as a sink device. In the case where the electronic device 101 operates as a sink device supplied with power, the external electronic device 2002 may operate as a source device.

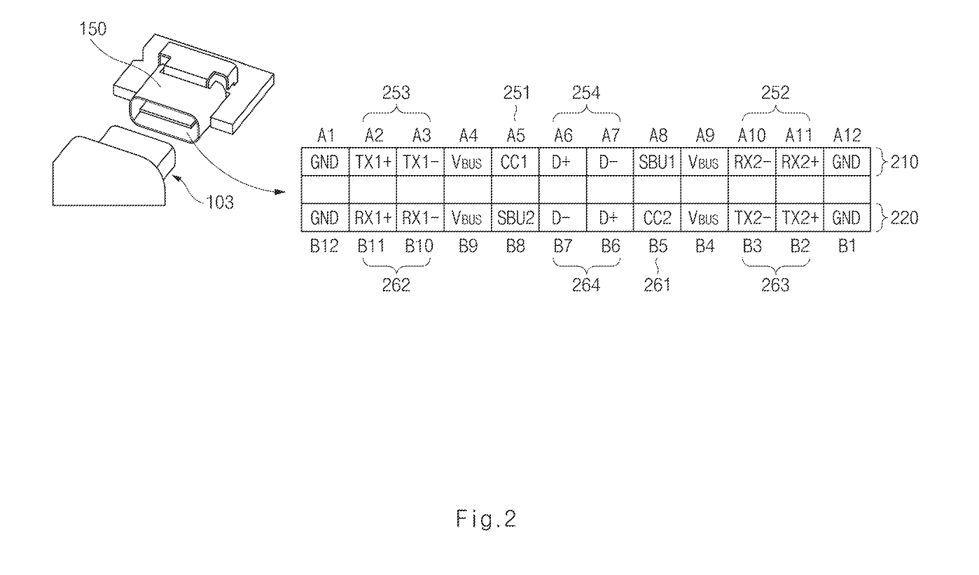

FIG. 2 illustrates a pinout of a connector according to various embodiments of the present disclosure.

Referring to FIG. 2, the connector 150 may include a first pin row 210 and a second pin row 220 that are implemented to be symmetrical in arrangement and locations. For example, the first pin row 210 may include 1st to 12th pins (e.g., a power pin, a ground pin, data pins (Tx, Rx, and D), a CC1 pin, and the like according to the USB standard specifications. The second pin row 220 may be symmetrical to the first pin row 210 in locations and arrangement and may include 13rd to 24th (e.g., a power pin, a ground pin, data pins (Tx, Rx, and D), a CC2 pin, and the like according to the USB standard specifications.

The data pins of the first pin row 210 may include RX pair pins 252, TX pair pins 253, and D pins 254. The RX pair pins 252 may include an RX2− pin (A10 pin) and an RX2+ pin (A11 pin). The TX pair pins 253 may include a TX1+ pin (A2 pin) and a TX1− pin (A3pin). The D pins 254 may include a D+ pin (A6 pin) and a D−pin (A7 pin). The RX pair pins 252 and the TX pair pins 253 may be data pins according to the USB 3.0, and the D pins 254 may be data pins according to the USB 2.0.

The data pins of the second pin row 220 may include RX pair pins 262, TX pair pins 263, and D pins 264. The RX pair pins 262 may include an RX1− pin (B10 pin) and an RX1+ pin (B11 pin). The TX pair pins 263 may include a TX2+pin (B2 pin) and a TX2−pin (B3 pin). The D pins 264 may include a D+ pin (B6 pin) and a D− pin (B7 pin). The RX pair pins 262 and the TX pair pins 263 may be data pins according to the USB 3.0, and the D pins 264 may be data pins according to the USB 2.0.

According to various embodiments, a first recognition pin 251 (CC1: A5 pin) and a second recognition pin 261 (CC2: B5 pin) may be pins for performing functions such as connection detection, identification of cable type, interface configuration, vendor defined messages, and the like.

The first recognition pin 251 (CC1: A5 pin) and the second recognition pin 261 (CC2: B5 pin) may be used to determine or switch the power-related role (source/sink device) or the data-related role (host device/client device) depending on a resistor connected to each of the first and second recognition pins 251 and 261.

For example, in the case where a first resistor Rd (e.g., 5.1 kΩ) is connected to the first recognition pin 251 and the second recognition pin 261 is in an open state, the electronic device 101 may operate as a host device, and the external electronic device 2002 may operate as a client device. In contrast, in the case where a second resistor Rp (e.g., 56 kΩ) is connected to the first recognition pin 251 and the second recognition pin 261 is in an open state, the electronic device 101 may operate as a client device, and the external electronic device 2002 may operate as a host device.

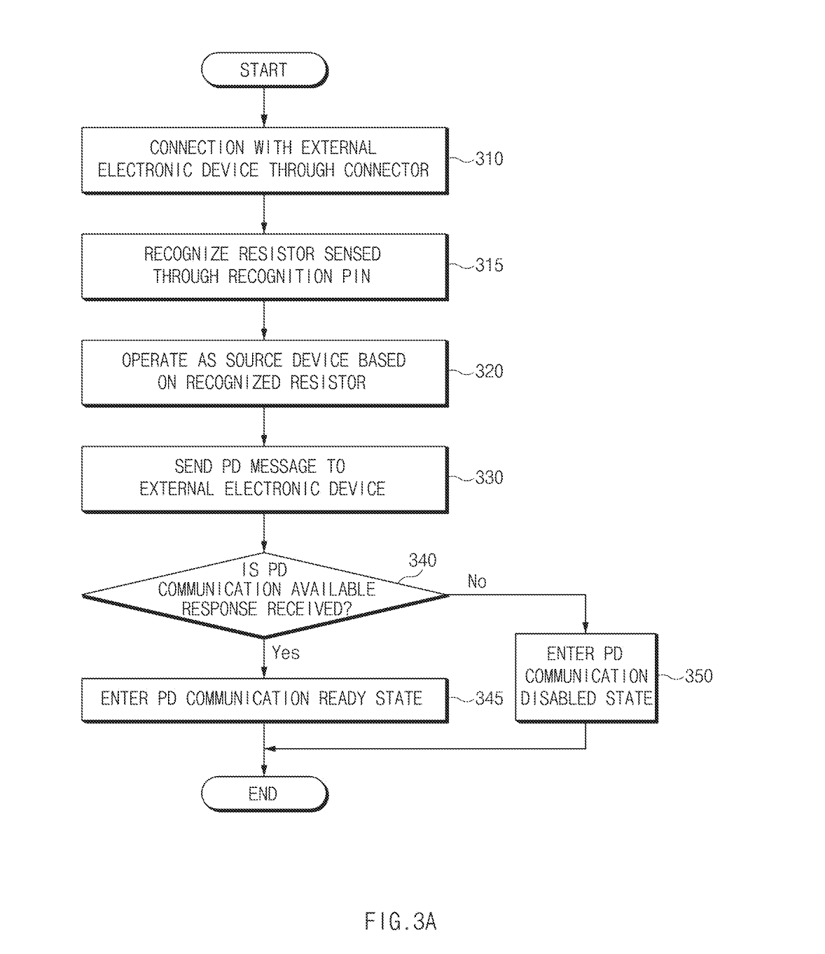

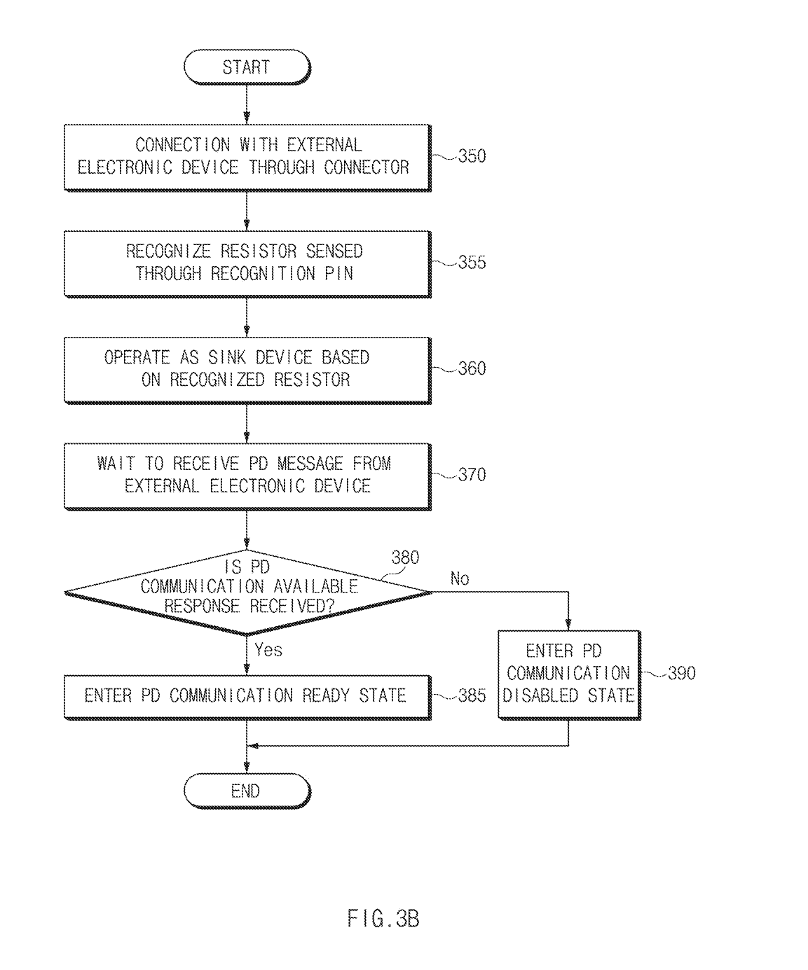

FIG. 3A is a flowchart illustrating a process for verifying a PD communication ready state at a source device, according to various embodiments of the present disclosure.

Referring to FIG. 3A, in operation 310, the electronic device 101 may be connected with the external electronic device 2002 through the connector 150. The connector 150 may be connected with the connector 2002a of the external electronic device 2002 directly or through the separate cable 103.

In operation 315, the electronic device 101 (e.g., the processor 130 or the connection configuration module 140) may recognize a resistor connected to the external electronic device 2002 (or a cable) sensed through the recognition pin 153.

In operation 320, the electronic device 101 (e.g., the processor 130 or the connection configuration module 140) may operate as a source device if the first resistor Rd (e.g., 5.1 kΩ) is recognized.

For example, in operation 315 to operation 320, the connection configuration module 140 of the electronic device 101 may be in a state of toggling the first resistor Rd (e.g., 5.1 kΩ) and the second resistor Rp (e.g., 56 kΩ) therein. Also, the connection configuration module 2002b of the external electronic device 2002 may be in a state of toggling the first resistor Rd (e.g., 5.1 kΩ) and the second resistor Rp (e.g., 56 kΩ) therein. In the case where the second resistor Rp (e.g., 56 kΩ) is connected within the connection configuration module 140 of the electronic device 101 and the first resistor Rd (e.g., 5.1 kΩ) is connected within the connection configuration module 2002b of the external electronic device 2002, the electronic device 101 may operate as a source device, and the external electronic device 2002 may operate as a sink device.

In an embodiment, the electronic device 101 (e.g., the processor 130 or the connection configuration module 140) may operate as a source device if the first resistor (pull-down resistor) Rd (e.g., 5.1 kΩ) is connected to the recognition pin 153. The electronic device 101 may be in a state in which power supply to the external electronic device 2002 is possible. In various embodiments, in the case where the electronic device 101 operates as a source device, the electronic device 101 may additionally perform an operation of collecting information about a status of the cable 103.

In operation 330, the electronic device 101 (e.g., the processor 130 or the connection configuration module 140) may send a PD message to the external electronic devices 2002. For example, the electronic device 101 may send the PD message associated with power supply to the external electronic device 2002. The electronic device 101 may verify a response to the connection configuration module 2002b of the external electronic device 2002 to determine whether it is possible to send the PD message. For example, the electronic device 101 may send a “SOURCE_Send_Capabilities” message to the external electronic device 2002 and may verify a response corresponding to the message.

In operation 340 and operation 345, if the electronic device 101 (e.g., the processor 130 or the connection configuration module 140) receives a PD communication available response from the external electronic device 2002, the electronic device 101 may enter a state (e.g., SOURCE_Ready) in which it is possible to support the PD communication.

In operation 350, if the electronic device 101 (e.g., the processor 130 or the connection configuration module 140) fails to receive a response, the electronic device 101 may enter a state (e.g., SOURCE_Disabled) in which it is impossible to support the PD communication.

In an embodiment, the electronic device 101 (e.g., the processor 130 or the connection configuration module 140) may store a PD communication ready state or a PD communication disabled state in a memory.

According to various embodiments, in the case where the electronic device 101 (e.g., the processor 130 or the connection configuration module 140) is in the PD communication ready state, the electronic device 101 may make a request for a change of the power-related role or the data-related role by using the PD message. In contrast, in the case where the electronic device 101 is in the PD communication disabled state, the electronic device 101 may change the power-related role or the data-related role by using a value change of a resistor connected to a recognition pin.

FIG. 3B is a flowchart illustrating a process for verifying a PD communication ready state at a sink device, according to various embodiments of the present disclosure.

Referring to FIG. 3B, in operation 350, the electronic device 101 may be connected with the external electronic device 2002 through the connector 150. The connector 150 may be connected with the connector 2002a of the external electronic device 2002 directly or through the separate cable 103.

In operation 355, the electronic device 101 (e.g., the processor 130 or the connection configuration module 140) may recognize a resistor connected to the external electronic device 2002 (or a cable) sensed through the recognition pin 153. For example, the second resistor Rp (e.g., 56 kΩ) may be connected to the recognition pin 153.

In operation 360, the electronic device 101 (e.g., the processor 130 or the connection configuration module 140) may operate as a sink device if the second resistor Rp (e.g., 56 kΩ) is recognized.

For example, in operation 355 to operation 360, the connection configuration module 140 of the electronic device 101 may be in a state of toggling the first resistor Rd (e.g., 5.1 kΩ) and the second resistor Rp (e.g., 56 kΩ) therein. Also, the connection configuration module 2002b of the external electronic device 2002 may be in a state of toggling the first resistor Rd (e.g., 5.1 kΩ) and the second resistor Rp (e.g., 56 kΩ) therein. In the case where the first resistor Rd (e.g., 5.1 kΩ) is connected within the connection configuration module 140 of the electronic device 101 and the second resistor Rp (e.g., 56 kΩ) is connected within the connection configuration module 2002b of the external electronic device 2002, the electronic device 101 may operate as a sink device, and the external electronic device 2002 may operate as a source device.

In an embodiment, the electronic device 101 may operate as a sink device if the second resistor (pull-up resistor) Rp (e.g., 56 kΩ) is connected to the recognition pin 153. The electronic device 101 may be in a state of waiting to receive power from the external electronic device 2002.

In operation 370, the electronic device 101 (e.g., the processor 130 or the connection configuration module 140) may wait to receive of a PD message from the external electronic device 2002. For example, the electronic device 101 may enter a “SINK_Wait for Capabilities” state to wait for the PD message (e.g., SOURCE_Send_Capabilities) of the external electronic device 2002.

In operation 380 and operation 385, if the electronic device 101 (e.g., the processor 130 or the connection configuration module 140) sends a PD communication ready response to the external electronic device 2002, the electronic device 101 may enter a state (SINK_Ready) in which it is possible to support the PD communication.

In operation 390, if the electronic device 101 (e.g., the processor 130 or the connection configuration module 140) does not send a response or sends a reject response to the external electronic device 2002, the electronic device 101 may enter a state (SINK_Disabled or State Error Recovery) in which it is impossible to support the PD communication.

In an embodiment, the electronic device 101 (e.g., the processor 130 or the connection configuration module 140) may store a PD communication ready state or a PD communication disabled state in a memory.

According to various embodiments, in the case where the electronic device 101 (e.g., the processor 130 or the connection configuration module 140) is in the PD communication ready state, the electronic device 101 may make a request for a change of the power-related role or the data-related role by using the PD message. In contrast, in the case where the electronic device 101 is in the PD communication disabled state, the electronic device 101 may change the power-related role or the data-related role by using a value change of a resistor connected to a recognition pin.

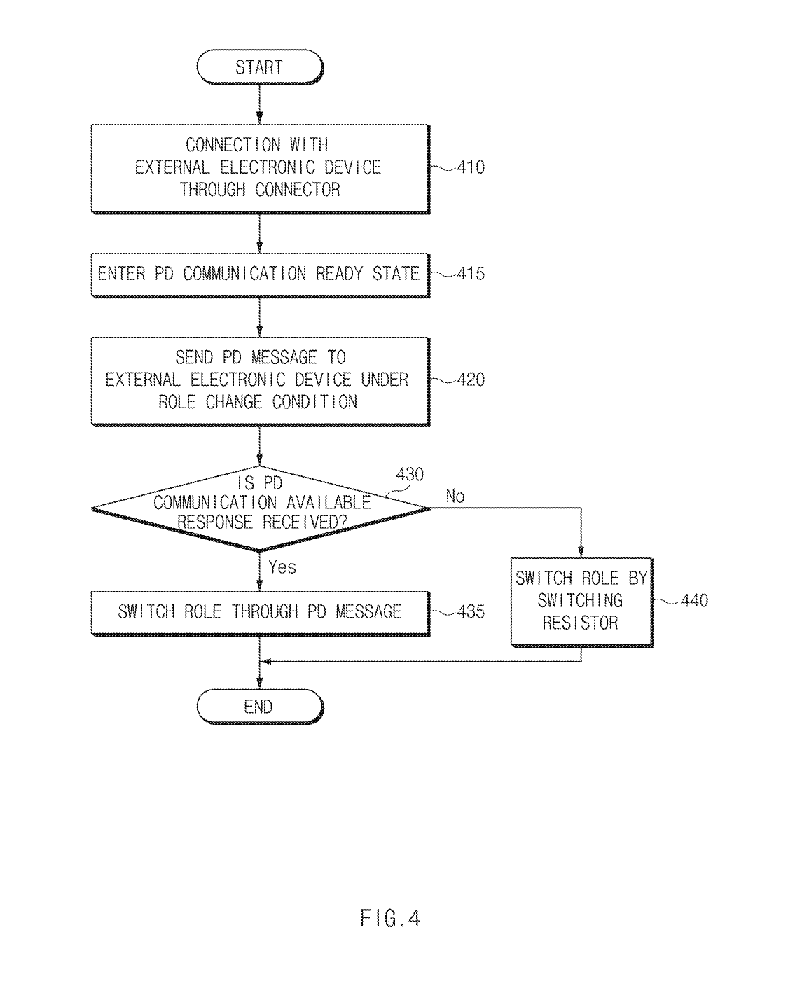

FIG. 4 is a flowchart for describing switching of a power-related role or a data-related role using a PD message according to various embodiments of the present disclosure.

Referring to FIG. 4, in operation 410, the electronic device 101 may be connected with the external electronic device 2002 through the connector 150. The connector 150 may be connected with the connector 2002a of the external electronic device 2002 directly or through the separate cable 103.

In operation 415, the electronic device 101 (e.g., the processor 130 or the connection configuration module 140) may enter a PD communication ready state (SOURCE_Ready or SINK_Ready) (operation 345 of FIG. 3A and operation 385 of FIG. 3B).

In operation 420, the electronic device 101 (e.g., the processor 130 or the connection configuration module 140) may send a PD message (e.g., PR_SWAP) associated with switching of the power-related role or a PD message (e.g., DR_SWAP) associated with switching of the data transfer-related role to the external electronic device 2002 under a role change condition. The role change condition may include the case that switching of the power-related role or switching of a data transfer-related role is requested by a state change (e.g., a change in a battery level, a start of wireless charging, or the like) of the electronic device 101, a user input, or an application.

In operation 430, the electronic device 101 (e.g., the processor 130 or the connection configuration module 140) may verify whether a PD communication ready response (e.g., ACK) is received from the connection configuration module 2002b of the external electronic device 2002.

If the electronic device 101 (e.g., the processor 130 or the connection configuration module 140) receives the PD communication ready response (e.g., ACK), in operation 435, the power-related role or the data transfer-related role may be switched depending on a PD message associated with role switching, and thus, at least one of a power supply direction or a data transfer direction may be changed.

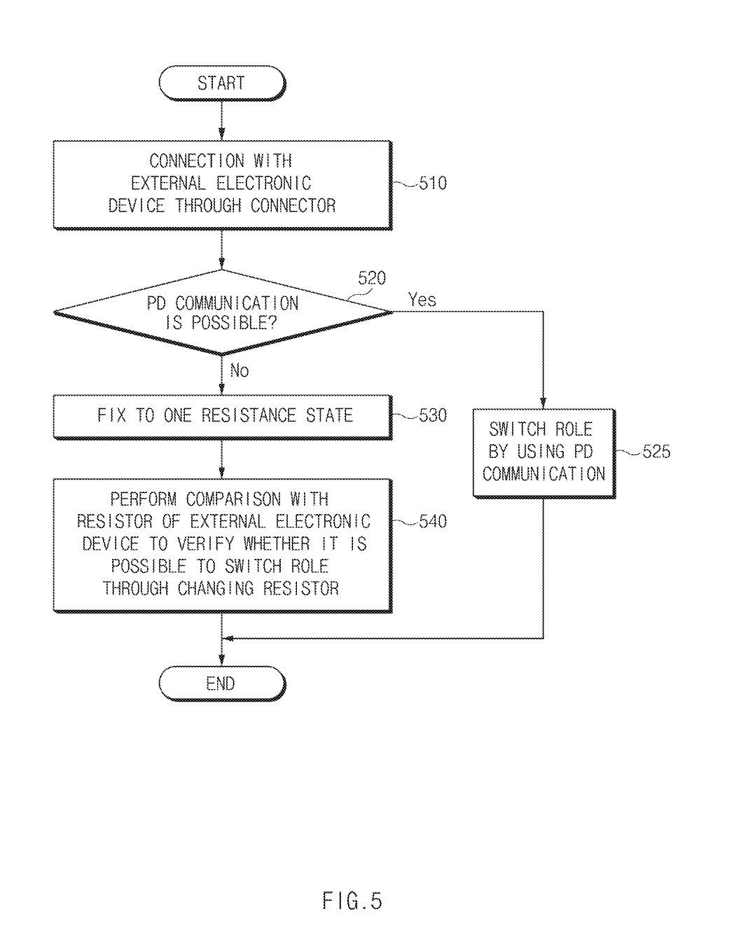

If the electronic device 101 (e.g., the processor 130 or the connection configuration module 140) fails to receive the PD communication ready response or receives a reject response (e.g., NAK), in operation 440, the electronic device 101 may switch a role depending on a way to switch a resistor in the connection configuration module 2002b (refer to FIG. 5).

According to various embodiments, operation 430 and operation 440 may be omitted. That is, in operation 435, the electronic device 101 (e.g., the processor 130 or the connection configuration module 140) may switch a role depending on a PD message associated with role switching regardless of receiving the PD communication ready response (e.g., ACK).

According to various embodiments, even in the case where the electronic device 101 (e.g., the processor 130 or the connection configuration module 140) is able to switch a role depending on a PD message, the electronic device 101 may switch a power-related role or a data transfer-related role through a way to switch a resistor.

According to various embodiments, in the case where the electronic device 101 satisfies the power change condition such as a battery state, a wireless charging state, a switching input of the user, or the like, the electronic device 101 may create a message associated with switching of a power role and may send the message to the connection configuration module 2002b of the external electronic device 2002.

For example, in the case where the electronic device 101 switches into a low battery state while sending data to the external electronic device 2002, the electronic device 101 may create a message associated with switching of a power role and may send the message to the external electronic device 2002 through the connection configuration module 140.

For example, the electronic device 101 may provide the user with a selection window associated with switching of a power role and may create a message associated with switching of a power role depending on a switching request of the user.

FIG. 5 is a flowchart for describing switching of a power-related role or a data transfer-related role using a resistance change according to various embodiments of the present disclosure.

Referring to FIG. 5, in operation 510, the electronic device 101 may be connected with the external electronic device 2002 through the connector 150. The connector 150 may be connected with the connector 2002a of the external electronic device 2002 directly or through the separate cable 103.

In operation 520, the electronic device 101 may verify whether PD communication with the external electronic device 2002 is possible. In the case where the external electronic device 2002 is first connected, the electronic device 101 may verify information that is stored depending on the process of FIG. 3A or 3B to verify whether it is possible to send the PD message.

If the PD communication is possible, in operation 525, the electronic device 101 may switch the power-related role or the data transfer-related role under a role change condition depending on operation 430 of FIG. 4. The role change condition may include the case that switching of the power-related role or switching of a data transfer-related role is requested by a state change (e.g., a change in a battery level, a start of wireless charging, or the like) of the electronic device 101, a user input, or an application.

If the PD communication is impossible, in operation 530, the electronic device 101 may fix the first resistor Rd (e.g., 5.1 kΩ) and the second resistor Rp (e.g., 56 kΩ) to one resistance state in a toggling state in the connection configuration module 140 and may connect a resistor fixed to the resistance state to the recognition pin 153. For example, the processor 130 may access a register of the connection configuration module 140 to fix a resistor of the recognition pin 153 to one of a pull-down resistor Rd or a pull-up resistor Rp in the toggling state.

In operation 540, the electronic device 101 may compare a resistor of the recognition pin 153 with a resistor of the external electronic device 2002 to verify whether it is possible to switch a role through changing a resistor. For example, if the resistor of the recognition pin 153 is fixed to the pull-down resistor Rd or the pull-up resistor Rp, detach may occur in a moment. During toggling, a resistor of the connection configuration module 2002b of the external electronic device 2002 may be connected to a resistor that is opposite to a resistor of the recognition pin 153. If the resistor of the external electronic device 2002 is different from the fixed resistor, the electronic device 101 may recognize the external electronic device 2002 as a device including the connection configuration module 2002b.

According to various embodiments, if the resistor of the external electronic device 2002 is the same as the fixed resistor, the electronic device 101 may recognize the external electronic device 2002 as a fixed resistance value (e.g., a legacy cable). In this case, switching of the power-related role or switching of the data transfer-related role may be impossible, and the electronic device 101 may deliver power or send data determined depending on a connected resistor.

According to various embodiments, in the case where a connection between devices is not established during a specified time (e.g., 3 to 5 seconds), the electronic device 101 may change the connection configuration module 140 to a toggling state.

FIG. 6A is a screen exemplification view for describing switching of a power-related role or a data transfer-related role according to selection of a user, according to various embodiments of the present disclosure.

Referring to FIG. 6A, the processor 130 may output a user interface that allows the power-related role or the data transfer-related role to be switched by a user input.

The processor 130 may display items that are able to switch in the electronic device 101 in the user interface, and the processor 130 may make selection of items, which are unable to switch in the electronic device 101, impossible or may not display the items being unable to switch.

In an embodiment, a role of the electronic device 101 may be fixed to either a “source device/host device” or a “sink device/client device”. In this case, in a power settings window 611 of a user interface 610, in the case where a source mode 611a is selected with regard to the power-related role, functions (e.g., power sharing, USB host, and the like) associated with operations of a host device may be displayed in a data settings window 612. In a power settings window 621 of a user interface 620, in the case where a sink mode 621a is selected with regard to the power-related role, functions (e.g., Media File Transfer, USB charging, Photo Transfer, Medi, MTP, PTP, and the like) associated with operations of a client device may be displayed in a data settings window 622.

In another embodiment, a role of the electronic device 101 may be fixed to a host device, and it may be impossible to set the power-related role separately. In this case, functions (e.g., Power sharing, USB Host, and the like) associated with operations of a host device may be displayed in a user interface 630.

In another embodiment, a role of the electronic device 101 may be fixed to a client device, and it may be impossible to set the power-related role separately. In this case, functions (e.g., Media File Transfer, USB charging, Photo Transfer, Medi, MTP, PTP, and the like) associated with operations of a client device may be displayed in a user interface 640.

FIG. 6B is a screen exemplification view illustrating a change of a user interface according to role switching failure, according to various embodiments of the present disclosures.

Referring to FIG. 6B, in the case where the electronic device 101 fails in attempting switching of the power-related role or the data transfer-related role, depending on selection of the user, the electronic device 101 may output relevant failure information or may automatically return to a previous role.

In screen 651, in the case where the electronic device 101 is connected with the external electronic device 2002 through the connector 150, a power-related role or a data transfer-related role may be determined and operated depending on default settings or selection of the user. For example, the electronic device 101 may operate in a state where a “Supplying power” option 660 is selected.

In screen 652, in the case where one 680 of power-related roles is selected by a user input 670, the USB framework 170 may store the selection of the user and may transfer a command for switching of the power-related role to the connection configuration module 140 through the device driver 180.

The connection configuration module 140 may attempt to switch into a selected role through a way to change a resistor or a way to use a PD message. In various embodiments, various role switching methods described with reference to FIGS. 3 to 5 may be performed. For example, the processor 130 may attempt role switching by attempting to switch pull-up/pull-down resistors of a register of the connection configuration module 140. For another example, the processor 130 may attempt to switch a role through PD communication.

In screen 653, the connection configuration module 140 may cancel switching in the case where switching into the selected role fails. For example, in the case where the external electronic device 2002 sends a reject response NAK to a PD message (PR_SWAP, DR_SWAP), the connection configuration module 140 may cancel role switching.

After attempting to switch a role, the connection configuration module 140 may provide the USB framework 170 with information about “newly set role (in success)” or “previously set role (in failure)”.

The processor 130 may determine a switching success/failure by comparing a “role according to selection of a user” previously stored and a “role provided from the connection configuration module 140” and may output the determination result through a display. For example, in the case where switching into the option 680 selected by the user fails, switching into a previous option 660 may be automatically made. In various embodiments, the processor 130 may display information about a role switching failure through a pop-up window or the like.

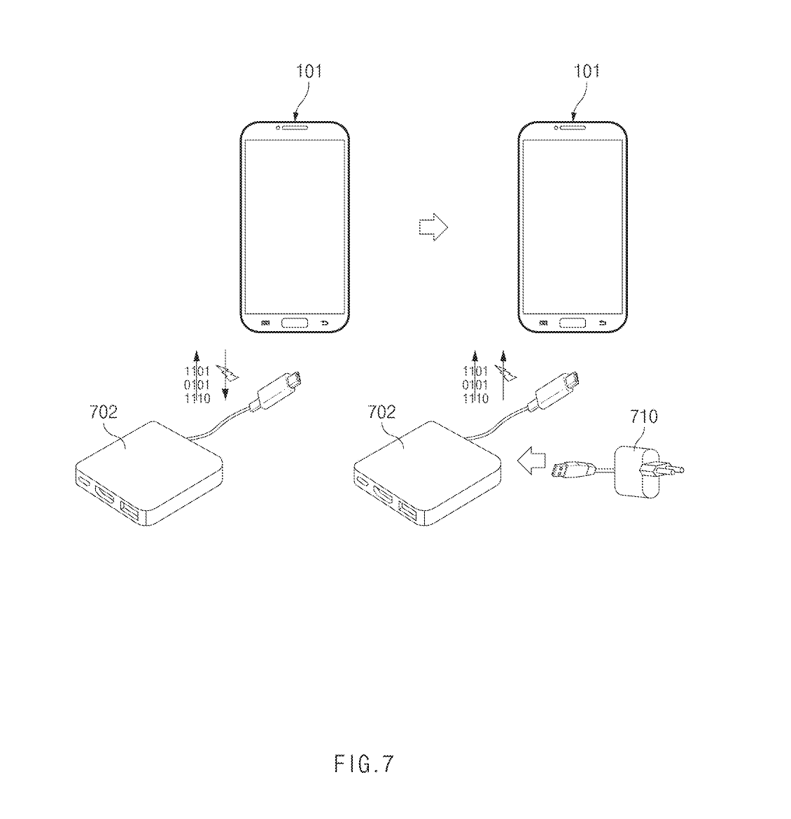

FIG. 7 is an exemplification view illustrating switching of a power-related role according to a connection with a power device, according to various embodiments of the present disclosures.

Referring to FIG. 7, the electronic device 101 may be connected to an accessory device 702 (e.g., a multi-port adapter). The electronic device 101 and the accessory device 702 may be in a state where it is possible to send and receive a power settings message.

The electronic device 101 may operate as a source device/host device while a separate wired power source is not connected to the accessory device 702. The electronic device 101 may supply power to the accessory device 702 and may receive data from the accessory device 702.

In the case where a wired power device (TA) 710 is connected to the accessory device 702, the accessory device 702 may be stably supplied with power and does not need to receive power from the electronic device 101. In this case, the accessory device 702 may make a request to the electronic device 101 for switching of the power-related role through a power setting message.

The accessory device 702 may request a change of the power-related role by a resistor change manner or a PD communication manner. In the case where the electronic device 101 responds to the request, the electronic device 101 may operate as a sink device, and the accessory device 702 may operate as a source device. In this case, the data-related role may be the same as a previous data-related role (the electronic device 101: a host device, and the accessory device 702: a client device).

Unlike FIG. 7, in the case of an accessory device always supplied with wired power, the electronic device 101 may operate as a sink device/client device, and the accessory device may operate a source device/host device. In this case, the electronic device 101 or the accessory device may make a request to a counterpart electronic device for switching of the data-related role through a message for changing of a PD communication manner.

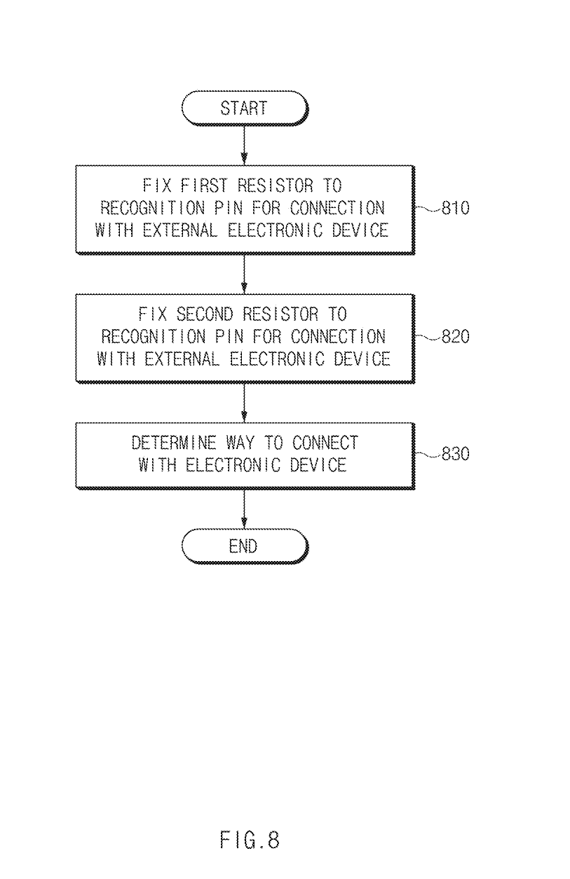

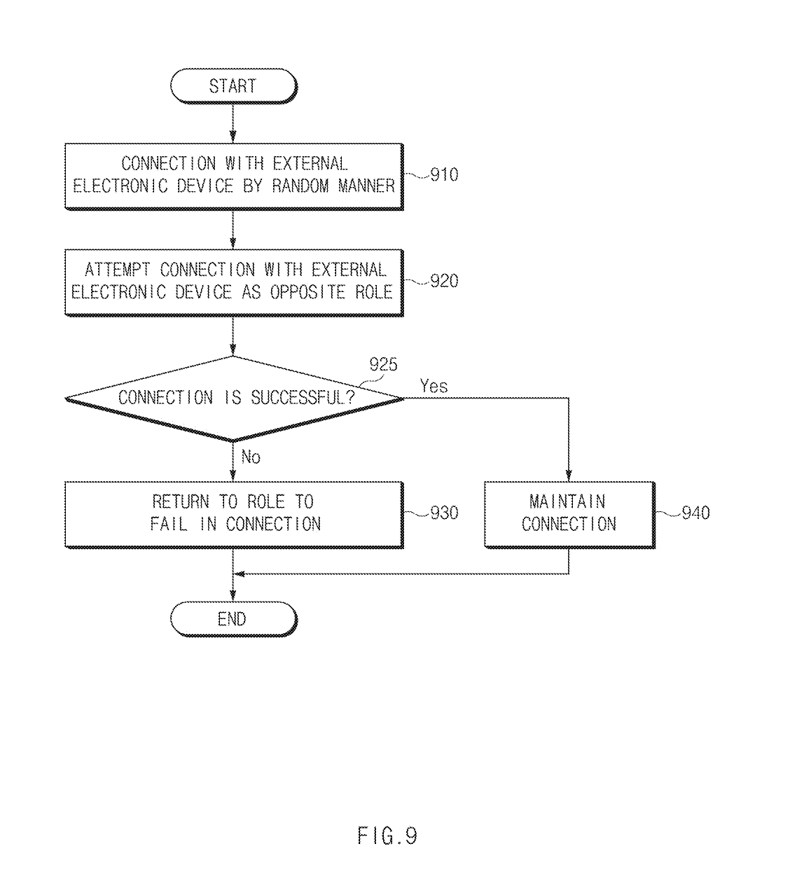

FIGS. 8 and 9 are flowcharts for describing a process for initial connection with an external electronic device according to various embodiments of the present disclosure.

Referring to FIG. 8, in operation 810, in the case where the external electronic device 2002 is first connected, the processor 130 may fix and connect the first resistor Rd (e.g., 5.1 kΩ) to the recognition pin 153 in the connection configuration module 140. The processor 130 may store information about whether a connection with the external electronic device 2002 succeeds or fails.

In operation 820, the processor 130 may fix and connect the second resistor Rp (e.g., 56 kΩ) to the recognition pin 153 in the connection configuration module 140. The processor 130 may store information about whether a connection with the external electronic device 2002 succeeds or fails.

In operation 830, the processor 130 may determine a way to connect with the external electronic device 2002, based on the stored connection information. For example, in the case where the connection with the external electronic device 2002 succeeds two times, the electronic device 101 may be switchable into a host device or a client device and may be connected with the external electronic device 2002 by a random manner. The electronic device 101 may display a user experience (UX) associated with a role switching to the user. In the case where the connection with the external electronic device 2002 succeeds once, the electronic device 101 may be connected with the external electronic device 2002 as a role of any one of a host device or a client device.

Referring to FIG. 9, in operation 910, in the case where the external electronic device 2002 is first connected, the connection configuration module 140 may connect the electronic device 101 with the external electronic device 2002 in a random manner. The processor 130 may store information about whether a connection with the external electronic device 2002 succeeds or fails. For example, the random manner may refer to a manner in which one of a pull-down resistor Rd or a pull-up resistor Rp is randomly fixed to the recognition pin 153 and a resistor of the connection configuration module 2002b of the external electronic device 2002 is connected to a resistor that is opposite to the resistor of the recognition pin 153 during toggling.

In operation 920, the processor 130 may attempt a connection with the external electronic device 2002 as a role that is opposite to a role connected in operation 910. The processor 130 may store information about whether a connection with the external electronic device 2002 succeeds or fails.

In operation 925 and operation 930, the processor 130 may return to a role to fail in connection in the case where the connection in operation 920 fails.

In operation 940, the processor 130 may maintain a current connection state in the case where the connection in operation 920 is successful.

In various embodiments, information about connection success or connection failure may be transferred to the USB framework 170. The USB framework 170 may verify a role and may allow an available role to be output in a user interface.

According to various embodiments, a method for recognizing an external electronic device is executed by an electronic device. The method includes recognizing a connection of a connector, mounted on the electronic device, with the external electronic device, verifying whether to convey a PD message is available through a recognition pin included in the connector, performing at least one of switching of a role associated with power supply of the electronic device or switching of a role associated with data transfer thereof by using at least one of the PD message or a way to change a resistor connected to the recognition pin, by using at least one of the PD message or a resistor connected to the recognition pin, depending on whether to convey the PD message is available.

According to various embodiments, the verifying includes sending the PD message to the external electronic device, receiving a PD communication ready message from the external electronic device through the connection configuration module, and entering a PD communication ready state.

According to various embodiments, the verifying includes sending the PD message to the external electronic device, waiting to receive the PD message from the external electronic device, sending a PD communication ready message through the connection configuration module if the PD message is received, and entering a PD communication ready state.

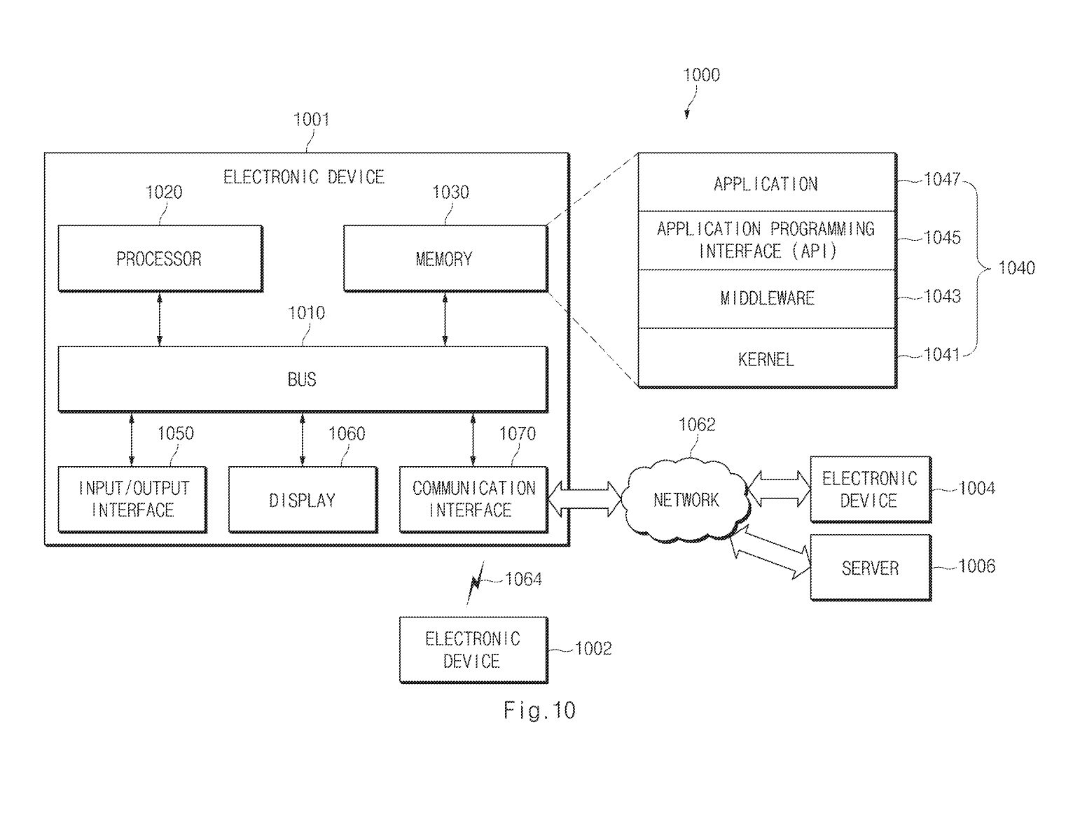

FIG. 10 illustrates an electronic device in a network environment according to an embodiment of the present disclosure of the present disclosure.

An electronic device 1001 in a network environment 1000 according to various embodiments of the present disclosure will be described with reference to FIG. 10. The electronic device 1001 may include a bus 1010, a processor 1020, a memory 1030, an input/output interface 1050, a display 1060, and a communication interface 1070. In various embodiments of the present disclosure, at least one of the foregoing elements may be omitted or another element may be added to the electronic device 1001.

The bus 1010 may include a circuit for connecting the above-mentioned elements 1010 to 1070 to each other and transferring communications (e.g., control messages and/or data) among the above-mentioned elements.

The processor 1020 may include at least one of a CPU, an AP, or a communication processor (CP). The processor 1020 may perform data processing or an operation related to communication and/or control of at least one of the other elements of the electronic device 1001.

The memory 1030 may include a volatile memory and/or a nonvolatile memory. The memory 1030 may store instructions or data related to at least one of the other elements of the electronic device 1001. According to an embodiment of the present disclosure, the memory 1030 may store software and/or a program 1040. The program 1040 may include, for example, a kernel 1041, a middleware 1043, an application programming interface (API) 1045, and/or an application program (or an application) 1047. At least a portion of the kernel 1041, the middleware 1043, or the API 1045 may be referred to as an operating system (OS).

The kernel 1041 may control or manage system resources (e.g., the bus 1010, the processor 1020, the memory 1030, or the like) used to perform operations or functions of other programs (e.g., the middleware 1043, the API 1045, or the application program 1047). Furthermore, the kernel 1041 may provide an interface for allowing the middleware 1043, the API 1045, or the application program 1047 to access individual elements of the electronic device 1001 in order to control or manage the system resources.

The middleware 1043 may serve as an intermediary so that the API 1045 or the application program 1047 communicates and exchanges data with the kernel 1041.

Furthermore, the middleware 1043 may handle one or more task requests received from the application program 1047 according to a priority order. For example, the middleware 1043 may assign at least one application program 1047 a priority for using the system resources (e.g., the bus 1010, the processor 1020, the memory 1030, or the like) of the electronic device 1001. For example, the middleware 1043 may handle the one or more task requests according to the priority assigned to the at least one application, thereby performing scheduling or load balancing with respect to the one or more task requests.

The API 1045, which is an interface for allowing the application 1047 to control a function provided by the kernel 1041 or the middleware 1043, may include, for example, at least one interface or function (e.g., instructions) for file control, window control, image processing, character control, or the like.

The input/output interface 1050 may serve to transfer an instruction or data input from a user or another external device to (an)other element(s) of the electronic device 1001. Furthermore, the input/output interface 1050 may output instructions or data received from (an)other element(s) of the electronic device 1001 to the user or another external device.

The display 1060 may include, for example, a liquid crystal display (LCD), a light-emitting diode (LED) display, an organic LED (OLED) display, a microelectromechanical systems (MEMS) display, or an electronic paper display. The display 1060 may present various content (e.g., a text, an image, a video, an icon, a symbol, or the like) to the user. The display 1060 may include a touch screen, and may receive a touch, gesture, proximity or hovering input from an electronic pen or a part of a body of the user.

The communication interface 1070 may set communications between the electronic device 1001 and an external device (e.g., a first external electronic device 1002, a second external electronic device 1004, or a server 1006). For example, the communication interface 1070 may be connected to a network 1062 via wireless communications or wired communications so as to communicate with the external device (e.g., the second external electronic device 1004 or the server 1006).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 1064. The short-range communications may include at least one of wireless fidelity (Wi-Fi), Bluetooth (BT), near field communication (NFC), magnetic stripe transmission (MST), or GNSS.

The MST may generate pulses according to transmission data and the pulses may generate electromagnetic signals. The electronic device 1001 may transmit the electromagnetic signals to a reader device such as a POS (point of sales) device. The POS device may detect the magnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), HDMI, recommended standard 832 (RS-232), plain old telephone service (POTS), or the like. The network 1062 may include at least one of telecommunications networks, for example, a computer network (e.g., local area network (LAN) or wide area network (WAN)), the Internet, or a telephone network.

The types of the first external electronic device 1002 and the second external electronic device 1004 may be the same as or different from the type of the electronic device 1001. According to an embodiment of the present disclosure, the server 1006 may include a group of one or more servers. A portion or all of operations performed in the electronic device 1001 may be performed in one or more other electronic devices (e.g., the first electronic device 1002, the second external electronic device 1004, or the server 1006). When the electronic device 1001 should perform a certain function or service automatically or in response to a request, the electronic device 1001 may request at least a portion of functions related to the function or service from another device (e.g., the first electronic device 1002, the second external electronic device 1004, or the server 1006) instead of or in addition to performing the function or service for itself. The other electronic device (e.g., the first electronic device 1002, the second external electronic device 1004, or the server 1006) may perform the requested function or additional function, and may transfer a result of the performance to the electronic device 1001. The electronic device 1001 may use a received result itself or additionally process the received result to provide the requested function or service. To this end, for example, a cloud computing technology, a distributed computing technology, or a client-server computing technology may be used.

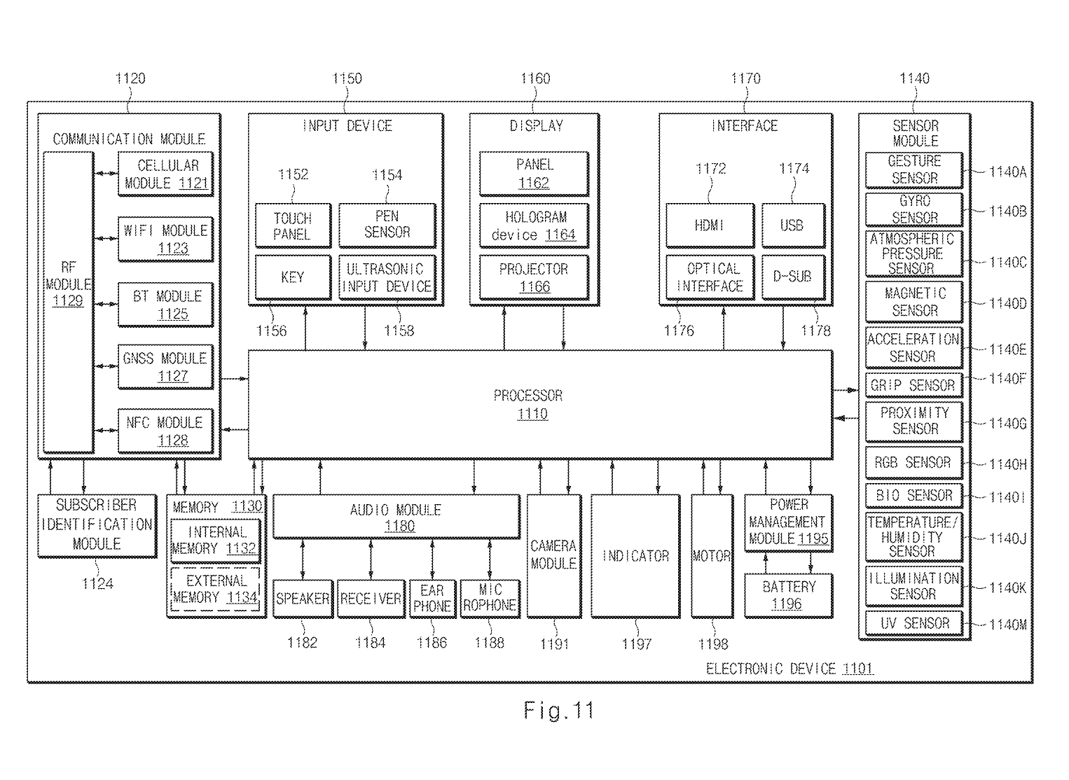

FIG. 11 is a block diagram illustrating an electronic device according to an embodiment of the present disclosure of the present disclosure.

Referring to FIG. 11, an electronic device 1101 may include, for example, a part or the entirety of the electronic device 1001 illustrated in FIG. 10. The electronic device 1101 may include at least one processor (e.g., AP) 1110, a communication module 1120, a subscriber identification module (SIM) 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may run an OS or an application program so as to control a plurality of hardware or software elements connected to the processor 1110, and may process various data and perform operations. The processor 1110 may be implemented with, for example, a system on chip (SoC). According to an embodiment of the present disclosure, the processor 1110 may further include a graphic processing unit (GPU) and/or an image signal processor (ISP). The processor 1110 may include at least a portion (e.g., a cellular module 1121) of the elements illustrated in FIG. 11. The processor 1110 may load, on a volatile memory, an instruction or data received from at least one of other elements (e.g., a nonvolatile memory) to process the instruction or data, and may store various data in a nonvolatile memory of the present disclosure.

The communication module 1120 may have a configuration that is the same as or similar to that of the communication interface 1070 of FIG. 10. The communication module 1120 may include, for example, a cellular module 1121, a Wi-Fi module 1123, a BT module 1125, a GNSS module 1127 (e.g., a GPS module, a GLONASS module, a BeiDou module, or a Galileo module), a NFC module 1128, and a radio frequency (RF) module 1129.

The cellular module 1121 may provide, for example, a voice call service, a video call service, a text message service, or an Internet service through a communication network. The cellular module 1121 may identify and authenticate the electronic device 1101 in the communication network using the subscriber identification module 1124 (e.g., a SIM card). The cellular module 1121 may perform at least a part of functions that may be provided by the processor 1110. The cellular module 1121 may include a CP.

Each of the Wi-Fi module 1123, the BT module 1125, the GNSS module 1127 and the NFC module 1128 may include, for example, a processor for processing data transmitted/received through the modules. According to some various embodiments of the present disclosure, at least a part (e.g., two or more) of the cellular module 1121, the Wi-Fi module 1123, the BT module 1125, the GNSS module 1127, and the NFC module 1128 may be included in a single IC or IC package.

The RF module 1129 may transmit/receive, for example, communication signals (e.g., RF signals). The RF module 1129 may include, for example, a transceiver, a power amp module (PAM), a frequency filter, a low noise amplifier (LNA), an antenna, or the like. According to another embodiment of the present disclosure, at least one of the cellular module 1121, the Wi-Fi module 1123, the BT module 1125, the GNSS module 1127, or the NFC module 1128 may transmit/receive RF signals through a separate RF module.

The SIM 1124 may include, for example, an embedded SIM and/or a card containing the subscriber identity module, and may include unique identification information (e.g., an integrated circuit card identifier (ICCID)) or subscriber information (e.g., international mobile subscriber identity (IMSI)).

The memory 1130 (e.g., the memory 1030) may include, for example, an internal memory 1132 or an external memory 1134. The internal memory 1132 may include at least one of a volatile memory (e.g., a dynamic RANI (DRAM), a static RAM (SRAM), a synchronous dynamic RAM (SDRAM), or the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD).

The external memory 1134 may include a flash drive such as a compact flash (CF), a secure digital (SD), a micro-SD, a mini-SD, an extreme digital (xD), a multi-media card (MMC), a memory stick, or the like. The external memory 1134 may be operatively and/or physically connected to the electronic device 1101 through various interfaces.

The sensor module 1140 may, for example, measure physical quantity or detect an operation state of the electronic device 1101 so as to convert measured or detected information into an electrical signal. The sensor module 1140 may include, for example, at least one of a gesture sensor 1140A, a gyro sensor 1140B, a barometric pressure sensor 1140C, a magnetic sensor 1140D, an acceleration sensor 1140E, a grip sensor 1140F, a proximity sensor 1140G, a color sensor 1140H (e.g., a red/green/blue (RGB) sensor), a biometric sensor 1140I, a temperature/humidity sensor 1140J, an illumination sensor 1140K, or an ultraviolet (UV) sensor 1140M. Additionally or alternatively, the sensor module 1140 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1140 may further include a control circuit for controlling at least one sensor included therein. In some various embodiments of the present disclosure, the electronic device 1101 may further include a processor configured to control the sensor module 1140 as a part of the processor 1110 or separately, so that the sensor module 1140 is controlled while the processor 1110 is in a sleep state.

The input device 1150 may include, for example, a touch panel 1152, a (digital) pen sensor 1154, a key 1156, or an ultrasonic input device 1158. The touch panel 1152 may employ at least one of capacitive, resistive, infrared, and UV sensing methods. The touch panel 1152 may further include a control circuit. The touch panel 1152 may further include a tactile layer so as to provide a haptic feedback to a user.

The (digital) pen sensor 1154 may include, for example, a sheet for recognition which is a part of a touch panel or is separate. The key 1156 may include, for example, a physical button, an optical button, or a keypad. The ultrasonic input device 1158 may sense ultrasonic waves generated by an input tool through a microphone 1188 so as to identify data corresponding to the ultrasonic waves sensed.

The display 1160 (e.g., the display 1060) may include a panel 1162, a hologram device 1164, or a projector 1166. The panel 1162 may have a configuration that is the same as or similar to that of the display 1060 of FIG. 10. The panel 1162 may be, for example, flexible, transparent, or wearable. The panel 1162 and the touch panel 1152 may be integrated into a single module. The hologram device 1164 may display a stereoscopic image in a space using a light interference phenomenon. The projector 1166 may project light onto a screen so as to display an image. The screen may be disposed in the inside or the outside of the electronic device 1101. According to an embodiment of the present disclosure, the display 1160 may further include a control circuit for controlling the panel 1162, the hologram device 1164, or the projector 1166.

The interface 1170 may include, for example, an HDMI 1172, a USB 1174, an optical interface 1176, or a D-subminiature (D-sub) 1178. The interface 1170, for example, may be included in the communication interface 1070 illustrated in FIG. 10. Additionally or alternatively, the interface 1170 may include, for example, a MHL interface, an SD card/MMC interface, or an infrared data association (IrDA) interface.

The audio module 1180 may convert, for example, a sound into an electrical signal or vice versa. At least a portion of elements of the audio module 1180 may be included in the input/output interface 1050 illustrated in FIG. 10. The audio module 1180 may process sound information input or output through a speaker 1182, a receiver 1184, an earphone 1186, or the microphone 1188.

The camera module 1191 is, for example, a device for shooting a still image or a video. According to an embodiment of the present disclosure, the camera module 1191 may include at least one image sensor (e.g., a front sensor or a rear sensor), a lens, an ISP, or a flash (e.g., an LED or a xenon lamp).

The power management module 1195 may manage power of the electronic device 1101. According to an embodiment of the present disclosure, the power management module 1195 may include a PMIC, a charger IC, or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1196 and a voltage, current or temperature thereof while the battery is charged. The battery 1196 may include, for example, a rechargeable battery and/or a solar battery.

The indicator 1197 may display a specific state of the electronic device 1101 or a part thereof (e.g., the processor 1110), such as a booting state, a message state, a charging state, or the like. The motor 1198 may convert an electrical signal into a mechanical vibration, and may generate a vibration or haptic effect. Although not illustrated, a processing device (e.g., a GPU) for supporting a mobile television (TV) may be included in the electronic device 1101. The processing device for supporting a mobile TV may process media data according to the standards of digital multimedia broadcasting (DMB), digital video broadcasting (DVB), MediaFLO™, or the like.

According to various embodiments, an electronic device includes a connector capable of being connected with an external electronic device, the connector including a recognition pin for sensing a connection with the external electronic device, a connection configuration module configured to control an operation of the connector by using the recognition pin, and a processor configured to control the connector and the connection configuration module, wherein the processor is configured to verify whether to convey a PD message is available through the recognition pin if the external electronic device is connected to the connector, and perform at least one of switching of a role associated with power supply of the electronic device or switching of a role associated with data transfer thereof by using at least one of a way to convey the PD message or a way to change a resistor connected to the recognition pin, depending on whether to convey the PD message is available.

According to various embodiments, the connection configuration module is toggling at a first resistor or a second resistor if the external electronic device is connected to the connector, and the processor is configured to recognize a kind of the external electronic device based on a resistor of the external electronic device recognized through the recognition pin.

According to various embodiments, the processor is configured to send the PD message to the external electronic device if the connection configuration module is connected with the second resistor and the external electronic device is connected with the first resistor.

According to various embodiments, the processor is configured to enter a PD communication ready state if a PD communication ready message is received through the connection configuration module with respect to the PD message.

According to various embodiments, the processor is configured to send a PD message for the switching of the role associated with the power supply or the switching of the role associated with the data transfer, to the external electronic device through the connection configuration module.

According to various embodiments, the processor is configured to attempt to switch a role with the external electronic device through a way to change the resistor connected to the recognition pin, if receiving a reject response through the connection configuration module or failing to receive a response to a specified time with regard to the PD message for the switching of the role associated with the power supply or the switching of the role associated with the data transfer.

According to various embodiments, the processor is configured to enter a PD communication disabled state if receiving a reject response through the connection configuration module or failing to receive a response during a specified time with regard to the PD message.

According to various embodiments, the processor is configured to switch a role with the external electronic device through a way to change the resistor connected to the recognition pin for the switching of the role associated with the power supply or the switching of the role associated with the data transfer.

According to various embodiments, the processor is configured to wait to receive the PD message from the external electronic device if the connection configuration module is connected with the first resistor and the external electronic device is connected with the second resistor.

According to various embodiments, the processor is configured to send a PD communication ready message and enter a PD communication ready state, if receiving the PD message through the connection configuration module.

According to various embodiments, the processor is configured to send the PD message for the switching of the role associated with the power supply or the switching of the role associated with the data transfer, to the external electronic device through the connection configuration module.

According to various embodiments, the processor is configured to enter a PD communication disabled state if failing to receive the PD message.

According to various embodiments, the processor is configured to perform the switching of the role associated with the power supply or the switching of the role associated with the data transfer, based on a status change of the electronic device or the external electronic device, an input of a user, or a request of an application.

According to various embodiments, the status change includes a change of at least one of a battery state, a heat state, a wireless charging state, and a charger connection state of the external electronic device.

According to various embodiments, the processor is configured to output a user interface for the switching of the role associated with the power supply or the switching of the role associated with the data transfer.

According to various embodiments, the processor is configured to dynamically change the user interface if the role associated with the power supply or the role associated with the data transfer is changed.

According to various embodiments, the recognition pin is a CC pin according to the USB standard, and the connection configuration module is a CC IC electrically connected to the CC pin.

Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a non-transitory computer-readable storage medium in the form of a program module. In the case where the instructions are performed by a processor (e.g., the processor 1020), the processor may perform functions corresponding to the instructions. The non-transitory computer-readable storage medium may be, for example, the memory 1030.

A non-transitory computer-readable recording medium may include a hard disk, a floppy disk, a magnetic medium (e.g., a magnetic tape), an optical medium (e.g., compact disc-read only memory (CD-ROM), digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

An electronic device according to various embodiments of the present disclosure may switch a power-related role and a data-related role in various manners, depending on a characteristic of an external electronic device connected through a connector.

The electronic device according to various embodiments of the present disclosure may provide a user experience (UX) screen for switching of the power-related role and the data-related role. The electronic device may dynamically change the UX screen depending on the characteristic of the external electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a connector configured to connect to an external electronic device, the connector including a recognition pin for sensing a connection with the external electronic device;
a connection configuration module configured to control an operation of the connector by using the recognition pin; and
a processor configured to control the connector and the connection configuration module,
wherein the processor is configured to:
if the external electronic device is connected to the connector, verify through the recognition pin whether communication of a power delivery (PD) message is possible; and
perform at least one of switching of a role associated with power supply of the electronic device or switching of a role associated with data transfer thereof by using at least one of a way to convey the PD message or a way to change a resistor connected to the recognition pin, depending on whether communication of the PD message is possible.

2. The electronic device of claim 1, wherein the connection configuration module toggles between at a first resistor or a second resistor if the external electronic device is connected to the connector, and
wherein the processor is configured to recognize a type of the external electronic device based on a resistor of the external electronic device recognized through the recognition pin.

3. The electronic device of claim 2, wherein the processor is configured to:
send the PD message to the external electronic device if the connection configuration module is connected with the second resistor and the external electronic device is connected with the first resistor.

4. The electronic device of claim 3, wherein the processor is configured to:
enter a PD communication ready state if a PD communication ready message is received through the connection configuration module with respect to the PD message.

5. The electronic device of claim 4, wherein the processor is configured to:
send a PD message for the switching of the role associated with the power supply or the switching of the role associated with the data transfer, to the external electronic device through the connection configuration module.

6. The electronic device of claim 5, wherein the processor is configured to:
attempt to switch a role with the external electronic device through a way to change the resistor connected to the recognition pin, if a rejection response is received through the connection configuration module or if a response is not received within a specified time, with regard to the PD message for the switching of the role associated with the power supply or the switching of the role associated with the data transfer.

7. The electronic device of claim 3, wherein the processor is configured to:
enter a PD communication disabled state if a reject response is received through the connection configuration module or if a response is not received within a specified time, with regard to the PD message.

8. The electronic device of claim 7, wherein the processor is configured to:
switch a role with the external electronic device through a way to change the resistor connected to the recognition pin for the switching of the role associated with the power supply or the switching of the role associated with the data transfer.

9. The electronic device of claim 2, wherein the processor is configured to:
wait to receive the PD message from the external electronic device if the connection configuration module is connected with the first resistor and the external electronic device is connected with the second resistor.

10. The electronic device of claim 9, wherein the processor is configured to:
send a PD communication ready message and enter a PD communication ready state, if the PD message is received through the connection configuration module.

11. The electronic device of claim 10, wherein the processor is configured to:
send the PD message for the switching of the role associated with the power supply or the switching of the role associated with the data transfer, to the external electronic device through the connection configuration module.

12. The electronic device of claim 9, wherein the processor is configured to:
enter a PD communication disabled state if the PD message is not received.

13. The electronic device of claim 1, wherein the processor is configured to:
perform the switching of the role associated with the power supply or the switching of the role associated with the data transfer, based on a status change of the electronic device or the external electronic device, an input of a user, or a request of an application.

14. The electronic device of claim 13, wherein the status change includes a change of at least one of a battery state, a heat state, a wireless charging state, and a charger connection state of the external electronic device.

15. The electronic device of claim 1, wherein the processor is configured to:
output a user interface for the switching of the role associated with the power supply or the switching of the role associated with the data transfer.

16. The electronic device of claim 15, wherein the processor is configured to:
dynamically change the user interface if the role associated with the power supply or the role associated with the data transfer is changed.

17. The electronic device of claim 1, wherein the recognition pin is a configuration channel (CC) pin according to the USB standard, and
wherein the connection configuration module is a CC integrated circuit (IC) electrically connected to the CC pin.

18. A method for recognizing an external electronic device, executed by an electronic device, the method comprising:
recognizing a connection of a connector, mounted on the electronic device, with the external electronic device;
verifying through a recognition pin included in the connector whether communication of a PD message is possible; and
performing at least one of switching of a role associated with power supply of the electronic device or switching of a role associated with data transfer thereof by using at least one of the PD message or a way to change a resistor connected to the recognition pin, by using at least one of the PD message or a resistor connected to the recognition pin, depending on whether communication of the PD message is possible.

19. The method of claim 18, wherein the verifying includes:
sending the PD message to the external electronic device;
receiving a PD communication ready message from the external electronic device through the connection configuration module; and
entering a PD communication ready state.

20. The method of claim 18, wherein the verifying includes:
sending the PD message to the external electronic device;
waiting to receive the PD message from the external electronic device;
sending a PD communication ready message through the connection configuration module if the PD message is received; and
entering a PD communication ready state.
